(19) United States
(12) Patent Application Publication
(10) Pub. No.: US 2026/0267989 A1
(43) Pub. Date: Sep. 10, 2026

(54) METHOD AND SYSTEM FOR APPLICATION SECURITY POSTURE MANAGEMENT PRIOR TO ACQUISITION OF SOFTWARE APPLICATIONS

(71) Applicant: Truist Bank, Charlotte, NC (US)

(72) Inventor: Brian Matthew White, Mint Hill, NC (US)

(73) Assignee: Truist Bank, Charlotte, NC (US)

(21) Appl. No.: 19/073,105

(22) Filed: Mar. 7, 2025

(51) Int. Cl. G06F 21/57

(52) U.S. Cl. CPC G06F 21/577; G06F 2221/033

(57) ABSTRACT

A method and system for certifying a level of security vulnerability of a software application from a developer prior to acquisition of the application by an organization includes the steps of: selecting a security vulnerability test to be performed on the application; setting an acceptable level of security vulnerability for the application; and selecting a tester to perform the test. The tester performs the test on the application and provides to the developer a full test report of results of the testing including a determined level of security vulnerability of the application. When the determined level of security vulnerability equals or is less than the acceptable level of security vulnerability, the tester provides to the organization a certification report including verification that the test was performed and that the determined level equals or is less than the acceptable level and excluding disclosure of any security vulnerabilities discovered.

The following disclosure relates generally to protecting against security vulnerabilities in software applications. More particularly, the disclosure relates to methods, systems and software for testing application security vulnerability prior to acquisition of a software application by an organization.

### BACKGROUND

Cybersecurity is a major issue in developing and maintaining software applications and websites. The NIST Cybersecurity Framework (CSF) is a set of voluntary guidelines designed to help organizations assess and improve their ability to prevent, detect, and respond to cybersecurity risks. Developed by the U.S. National Institute of Standards and Technology (NIST), the framework was initially published in 2014 for critical infrastructure sectors but has since been widely adopted across various industries, including government and private enterprises globally. The first version of the Framework (CSF 1.0) was released in 2014 and was updated in 2018 (CSF 1.1). To reflect the ever-evolving cybersecurity landscape and to help organizations more easily and effectively manage cybersecurity risk, NIST developed a new—updated version—of the Framework (CSF 2.0) in 2024. The framework integrates existing standards, guidelines, and best practices to provide a structured approach to cybersecurity risk management.

The Cybersecurity and Infrastructure Security Agency (CISA) is a component of the United States Department of Homeland Security (DHS) responsible for cybersecurity and infrastructure protection across all levels of government, coordinating cybersecurity programs with U.S. states, and improving the government's cybersecurity protections against private and nation-state hackers. The term cyber attack covers a wide variety of actions ranging from simple probes, to defacing websites, to denial of service, to espionage and destruction. On Oct. 25, 2023 CISA and 17 U.S. and international partners published an update to the joint Secure by Design product, “Shifting the Balance of Cybersecurity Risk: Principles and Approaches for Secure by Design Software,” that includes expanded principles, guidance, and eight new international agency co-sealers. Initially published in April 2023, this joint guidance urges software manufacturers to take urgent steps necessary to ship products that are secure by design and revamp their design and development programs to permit only secure by design products to be shipped to customers. It expands on the three principles which are: Take Ownership of Customer Security Outcomes, Embrace Radical Transparency and Accountability, and Lead From the Top. This update highlights how software manufacturers can demonstrate these principles to their customers and the public.

CrowdStrike (Sunnyvale, CA) defines application security posture management (ASPM) as the holistic process of evaluating, managing, and enhancing the security stance of an organization's custom applications. See What is Application Security Posture Management (ASPM) by Jamie Gale, May 14, 2024, at crowdstrike.com/en-us/cybersecurity-101/application-security/application-security-posture-management-aspm/. It ensures applications adhere to security standards, resist cyber threats, and remain compliant. ASPM tools identify vulnerabilities, assess risks, and prioritize mitigations, enabling organizations to safeguard sensitive data, prevent breaches, and ensure compliance with industry regulations.

Many businesses rely on development teams to innovate quickly so they can deliver better products, services, and experiences through applications. However, the widespread reliance on applications requires vigilant measures to prevent potential exploitation, data breaches, or compliance violations. In software development, where new threats constantly emerge, ASPM ensures that applications are rigorously assessed, allowing for swift identification, triage, and prioritization of potential risks throughout the software development life cycle.

ASPM is a part of an organization's overall security strategy focused on the specialized practice of securing applications. While network security, cloud security, and other security focus areas are vital, securing applications is equally important. Many cyberattacks target vulnerabilities in applications, making it a critical component of an organization's security practices. It also helps support an organization's incident response protocols by providing essential insights that show what sensitive data—such as personally identifiable information (PII), protected health information (PHI), information subject to Payment Card Industry (PCI) regulations, and intellectual property—is at risk and where it lives to facilitate effective remediation.

Various techniques are known in the art for testing and protecting software applications against security vulnerabilities. A “vulnerability” in this context is a flaw or weakness in the application program that can be exploited by an unauthorized party (also referred to as an attacker) to gain access to secure information or otherwise modify the behavior of the program. For example, static application security testing (SAST) techniques are typically applied in order to detect security vulnerabilities in source code before the code is compiled and run. Dynamic application security testing (DAST), on the other hand, approaches the application as a “black box,” and attempts to find vulnerabilities by bombarding the application during runtime with potentially harmful inputs.

As another example, runtime application self-protection (RASP) techniques can be used to protect software applications against security vulnerabilities by adding protection features into the application. In typical RASP implementations, these protection features are instrumented into the application runtime environment, for example by making appropriate changes and additions to the application code and/or operating platform. The instrumentation is designed to detect suspicious behavior during execution of the application and to initiate protective action when such behavior is detected. RASP techniques are described, for example, in U.S. Pat. No. 10,120,997 B2.

Interactive application security testing (IAST) combines features of DAST and other testing techniques. This sort of approach is described, for example, in PCT International Publication No. WO 2017/163141 A1. After recording a sequence of functional tests that are applied to a program under test, the LAST system automatically modifies one or more of the recorded functional tests to contain attack payloads, and then applies the modified tests to the application in order to detect security vulnerabilities in the program. These IAST scenarios may be run in conjunction with instrumentation of the application code in order to facilitate automatic identification of security vulnerabilities.

ASPM tools are available from a number of vendors that specialize in safeguarding software at every phase of development and beyond. Such vendors include: Cycode; Snyk Code; SentinelOne; Veracode; Checkmarx; Contrast Security; and Mend.io.

A conflict can arise when an enterprise organization seeks to use a software application from an independent software developer. While the developer may have used ASPM techniques to evaluate the software application for security vulnerabilities, the developer typically will not share the detailed results of the evaluation with the enterprise organization. Therefore, improvements are needed to enable an organization to evaluate the security posture of a software application from an independent developer.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a method for certifying a level of security vulnerability of a software application to an organization prior to acquisition of the software application from a developer comprises steps of: selecting a security vulnerability test to be performed on the software application; setting an acceptable level of security vulnerability for the software application as determined by the security vulnerability test; selecting a tester to perform the security vulnerability test; the tester operating a computing system to perform the security vulnerability test on the software application, the computing system generating a full test report of results of the security vulnerability test including a determined level of security vulnerability of the software application; the developer receiving the full test report from the tester; when the determined level of security vulnerability equals or is less than the acceptable level of security vulnerability, the developer authorizing the tester to provide to the organization a certification report including verification that the security vulnerability test was performed and that the determined level of security vulnerability is equal to or is less than the acceptable level of security vulnerability, the certification report excluding disclosure of any security vulnerabilities discovered during performance of the security vulnerability test; and the tester providing the certification report to the organization.

The method includes wherein the full test report includes details of all security vulnerabilities discovered during performance of the security vulnerability test. The security vulnerability test can be a dynamic application security test or an interactive application security test. When the determined level of security vulnerability exceeds the acceptable level of security vulnerability, the developer makes at least one change to the software application and the method returns to the step of the tester performing the security vulnerability test.

The method includes a step of selecting an additional test to be performed on the software application by the tester, the additional test being one of unit testing, dynamic application security testing, interactive application security testing, regression testing, integration testing, user acceptance testing, and performance testing. When the results of the testing indicate that the determined level of security vulnerability equals or is less than the acceptable level of security vulnerability, the additional test is performed on the software application and the results of the additional test are included in the full test report.

The method includes a step of selecting additional tests to be performed on the software application by the tester and, when the results of the testing indicate that the determined level of security vulnerability equals or is less than the acceptable level of security vulnerability, performing the additional tests on the software application and including results of the additional tests in the full test report. After each of the additional tests is performed, checking is done as to whether all of the additional tests were performed.

The method includes a step of, when the results of the testing for each of the additional tests indicate that a determined level of security vulnerability equals or is less than an acceptable level of security vulnerability, including results of the additional test in the full test report and selecting another of the additional tests to be performed. The certification report includes verification that the additional tests were performed and that the software application equals or is less than the acceptable level of security vulnerability for each of the additional tests.

In yet another embodiment, a method for application security posture management prior to acquisition of a software application by an organization comprises steps of: selecting a security vulnerability test to be performed on the software application; selecting an additional test to be performed on the software application; setting, by the organization, an acceptable level of security vulnerability for the software application; selecting a tester to perform the tests; the tester operating a computing system to perform the tests on the software application, the computing system generating a full test report of results of the testing including a determined level of security vulnerability of the software application; the developer receiving the full test report from the tester; and when the determined level of security vulnerability equals or is less than the acceptable level of security vulnerability, the tester providing to the organization a certification report including verification that the tests were performed and that the software application equals or is less than the acceptable level of security vulnerability, the certification report excluding disclosure of any security vulnerabilities discovered during performance of the tests.

The full test report includes details of all security vulnerabilities discovered during performance of the security vulnerability test.

The additional test is one of unit testing, dynamic application security testing, interactive application security testing, regression testing, integration testing, user acceptance testing, and performance testing. When the results of the testing indicate that the determined level of security vulnerability equals or is less than the acceptable level of security vulnerability, the additional test is performed on the software application and the results of the additional test are included in the full test report.

The certification report includes verification that the additional tests were performed and that the determined level of security vulnerability equals or is less than the acceptable level of security vulnerability for each of the additional tests.

In yet another embodiment, to which the above examples also apply as well, a tester computing system is configured to implement a method for certifying a level of security vulnerability of a software application from a developer prior to acquisition of the software application by an organization, the computing system comprising: a non-transitory storage device; a processor operatively coupled with the storage device; a communication interface coupled with the processor, in communication with a computing system of a developer of a software application and in communication with a computing system of a software application tester; a software security management application stored in the storage device and including executable code that, when executed, causes the processor to, select a security vulnerability test to be performed on the developer software application; set an acceptable level of security vulnerability for the developer software application as determined by the security vulnerability test; perform the security vulnerability test on the developer software application and to generate to the developer a full test report of results of the testing including a determined level of security vulnerability of the developer software application; when the determined level of security vulnerability equals or is less than the acceptable level of security vulnerability, generate a certification report including verification that the security vulnerability test was performed and that the determined level of security vulnerability equals or is less than the acceptable level of security vulnerability, the certification report excluding disclosure of any security vulnerabilities discovered during performance of the security vulnerability test; and provide the certification report to the organization.

The full test report includes details all security vulnerabilities discovered during performance of the security vulnerability test.

The security vulnerability test can be a dynamic application security test or an interactive application security test.

The processor selects an additional test to be performed on the software application by the tester, the additional test being one of unit testing, dynamic application security testing, interactive application security testing, regression testing, integration testing, user acceptance testing, and performance testing.

The processor selects additional tests to be performed on the software application by the tester and wherein the certification report includes verification that the additional tests were performed and that the determined level of security vulnerability equals or is less than the acceptable level of security vulnerability for each of the additional tests.

The above summary is to be understood as cumulative and inclusive. The above described embodiments and features are combined in various combinations in whole or in part in one or more other embodiments.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 illustrates an enterprise system and environment thereof, in accordance with various embodiments of the invention.

FIG. 2 shows a block diagram that schematically illustrates a prior art system for testing a software application.

FIG. 3 is a flow chart that schematically illustrates a prior art method for managing vulnerabilities in a software application.

FIG. 4 is a schematic representation of a computer screen generated by a security station in accordance with the system shown in FIG. 2 and the method shown in FIG. 3.

FIG. 5 is a flow chart of a method, according to the invention, for application security posture management prior to acquisition of a software application by an organization.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the invention described herein, with reference to illustrations and/or block diagrams of systems and apparatuses (the term “apparatus” includes systems and computer program products), will be understood such that each function described or implied with reference to the illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts described, illustrated, and/or implied.

These computer program instructions may also be stored in a computer-readable memory that can direct a computer or other programmable data processing apparatus to function in a particular manner, such that the instructions stored in the computer readable memory produce an article of manufacture including instructions, which implement the function/act described, illustrated, and/or implied.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts described, illustrated, and/or implied. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein. Where functions of hardware and software are described herein, related methods are detailed therewith, such that methods are disclosed as well.

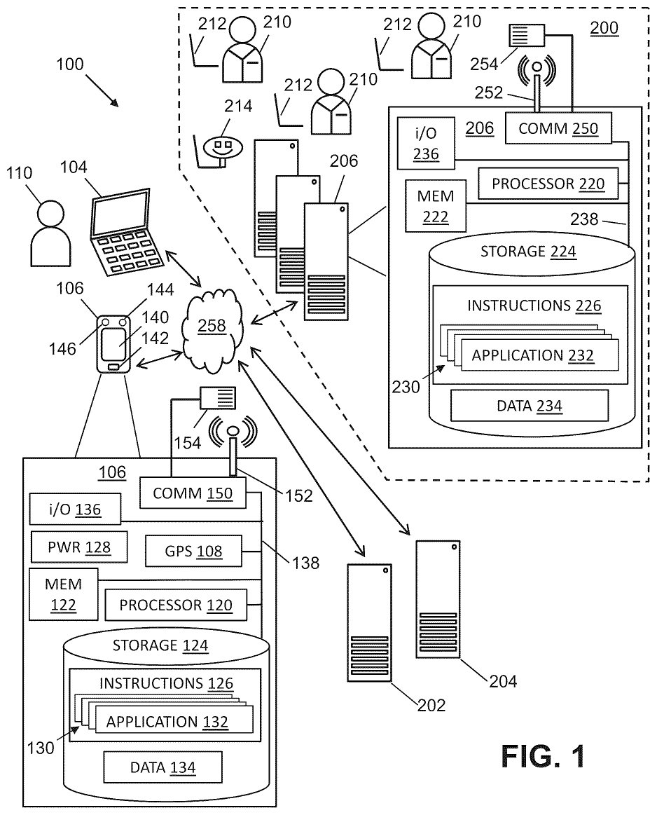

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog computing environment, and/or an edge computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning system device (GPS) configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third and fourth party systems such as merchant systems configured to interact with the user device 106 during transactions and also configured to interact with the enterprise system 200 in back-end transactions clearing processes.

In certain embodiments, one or more of the systems and devices, such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The enterprise organization operating the above-described system 200 can add to and/or update software applications that are stored in the storage device 224. Software application developers can use CI/CD pipelines that are formalized software development workflows and tool sets intended to provide a defined path for building, testing and delivering modern software. In a CI/CD pipeline, everything is designed to happen simultaneously: Some software iterations are being coded, other iterations are being tested and others are heading for deployment. Still, there are important tradeoffs between CI/CD benefits and drawbacks. Oversights and mistakes in programming and testing can create vulnerabilities and expose software to malicious activity. Thus, it is critical to infuse security best practices throughout the CI/CD pipeline. Tools such as vulnerability checkers can help spot potential security flaws in the code flowing through the pipeline, while additional security evaluations should take place during the testing phase.

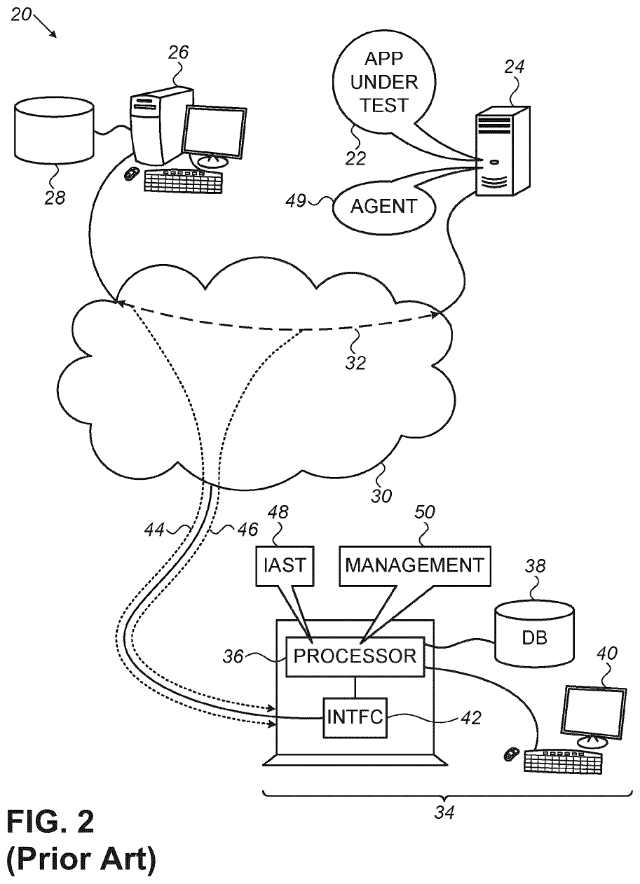

New applications and updated applications typically are subjected to vulnerabilities tests prior to installation. For example, Checkmarx Ltd., of Ramat Gan, IL, describes in U.S. Pat. No. 11,170,113 B2 a method for testing a software program for security vulnerabilities. FIG. 2 (FIG. 1 of the patent) is a block diagram that schematically illustrates a system 20 for testing a software application 22, in accordance with an embodiment of the method. In the example shown in FIG. 2, application 22 is assumed to be a client/server application, such as a Web application, which runs on a server 24. A client station 26 applies test scenarios to application 22, for example by conveying requests to and receiving responses from server 24 via a network 30. The test scenarios are stored in a memory 28 of client station 26, and the requests and responses normally travel over a path 32 through network 30.

A test and management station 34 runs an IAST tool 48, which communicates with an IAST agent 49 running on server 24. IAST tool 48 may operate in a passive mode, in which the IAST tool simply receives and processes reports from IAST agent 49. Optionally, IAST tool 48 may also actively send test instructions to and record communications between client station 26 and server 24 in order to generate and apply security tests to application 22. Prior to the execution of application 22, IAST agent 49 instruments the program code of the application with instructions configured to detect the security vulnerabilities and output the location and metadata with respect to the control flow path of each of these security vulnerabilities. These instrumentation and testing functions of IAST tool 48 and agent 49 are described in detail, for example, in WO 2016/108162 and WO 2017/163141 publications. Additionally or alternatively, station 34 may run other sorts of static and dynamic test tools that are known in the art. In addition, station 34 runs a vulnerability management tool 50, whose general features and capabilities have been described above. Further details of vulnerability management tool 50 are presented hereinbelow.

Test and management station 34 typically comprises a general-purpose computer, comprising a processor 36, which is programmed in software to carry out the functions that are described herein. Tools 48 and 50 typically comprise software programs of this sort. This software may be downloaded to station 34 in electronic form, over a network, for example.

Test and management station 34 comprises a memory 38, which stores a security vulnerability database, and a user interface 40, which enables testing personnel to manipulate the test scenarios that IAST tool 48 applies to application 22 (when operating in an active mode) and to view test results and vulnerability reports generated by processor 36. Station 34 is coupled to network 30 by a suitable network interface 42. Station 34 is thus able to intercept and record requests submitted by client station 26 to server 24, via an input path 44, and to intercept and record responses from server 24, via an output path 46. Security test scenarios developed by IAST tool 48 may be applied to server 24 by processor 36 over output path 46; or they may, alternatively or additionally, be downloaded to client station 26 for application to server 24.

The security vulnerability database in memory 38 (referred to hereinafter simply as a “vulnerability database”) contains records of security vulnerabilities that have been identified in execution of the program under test—application 22 in the present example. Each record corresponds to a security vulnerability that was detected in one or more execution runs and comprises a location field containing a signature indicating the location in the execution at which the vulnerability was detected. Each record also contains a metadata field, with information indicative of the control flow path on which the corresponding security vulnerability occurred. Specifically, in the present embodiment, the metadata field in each record contains a hash computed over the location, the control flow path, and the type of the corresponding security vulnerability.

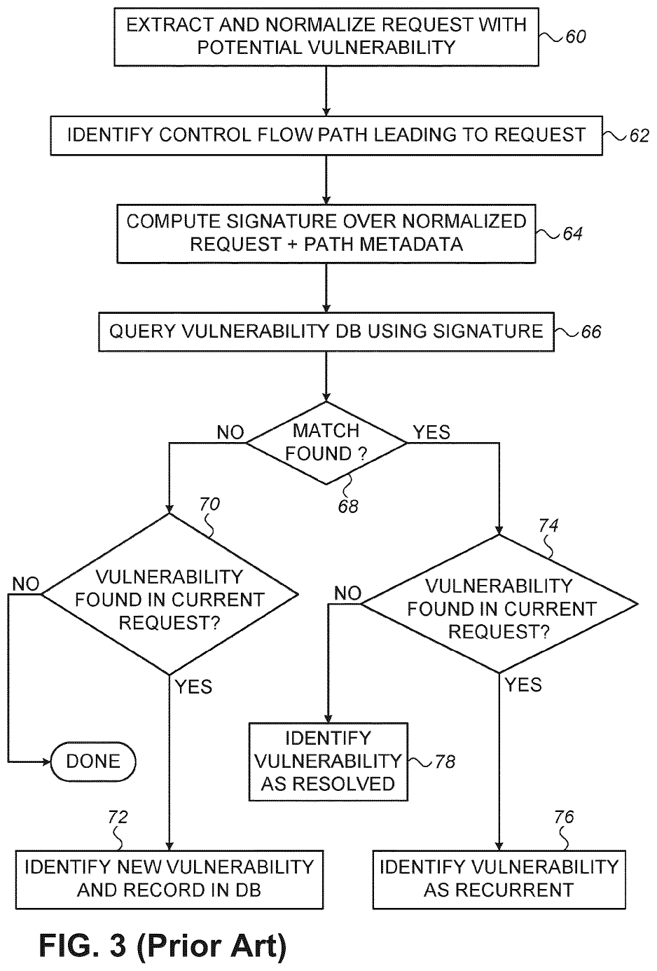

FIG. 3 (FIG. 2 of the patent) is a flow chart, which schematically illustrates a method for managing vulnerabilities in a software application. This method is described, for the sake of convenience and clarity, with reference to testing of application 22 in the context of system 20, as shown in FIG. 2, and using the vulnerability database that was described above.

The vulnerability database in memory 38 with respect to application 22 is typically built up and maintained by management tool 50, running on processor 36, over multiple execution runs, and typically over multiple different versions in the development life cycle of the application. As explained below in greater detail, when IAST tool 48 detects a security vulnerability at a given location in an execution of application 22, processor 36 computes the signature of the given location (after first normalizing any variable parameters) and compares this signature to the location signatures of the records in the database. When no record is found to match the new location signature, processor 36 outputs an indication to the program developer that a new security vulnerability has occurred. Typically, processor 36 will add a new record to the database with respect to this new security vulnerability. A detailed description of the steps 60 through 78 is found in the patent.

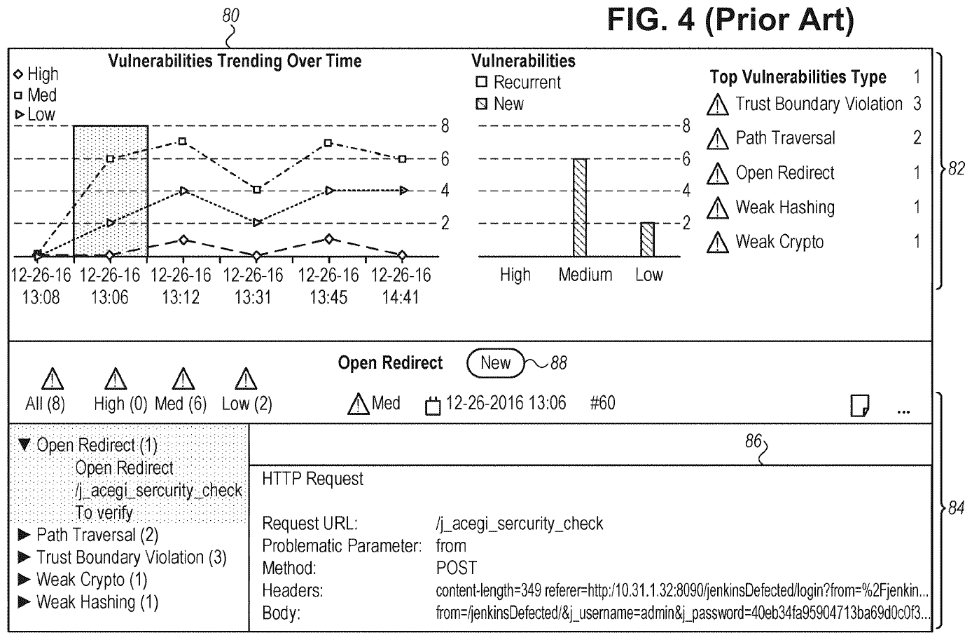

FIG. 4 (FIG. 3A of the patent) is a schematic representation of computer screen 80 generated by test and management station 34. Management tool 50 generates screen 80 based on the status of the vulnerability database in memory 38, including both general features and specific vulnerabilities. A general area 82 shows the overall status of the vulnerability database, including numbers and types of vulnerabilities. A tracking area 84 shows the details and status of selected individual vulnerabilities.

In the pictured example, tracking area 84 shows an Open Redirect vulnerability, with location and path parameters listed in a request parameters block 86. In FIG. 4, this vulnerability has been identified for the first time (on Dec. 26, 2016) and is marked with a “new” flag 88. The same vulnerability found to recur in a later execution of the program would have the flag 88 marked “recurrent.” If the vulnerability is no longer found in a program version subsequently executed, the flag 88 then is marked “resolved”.

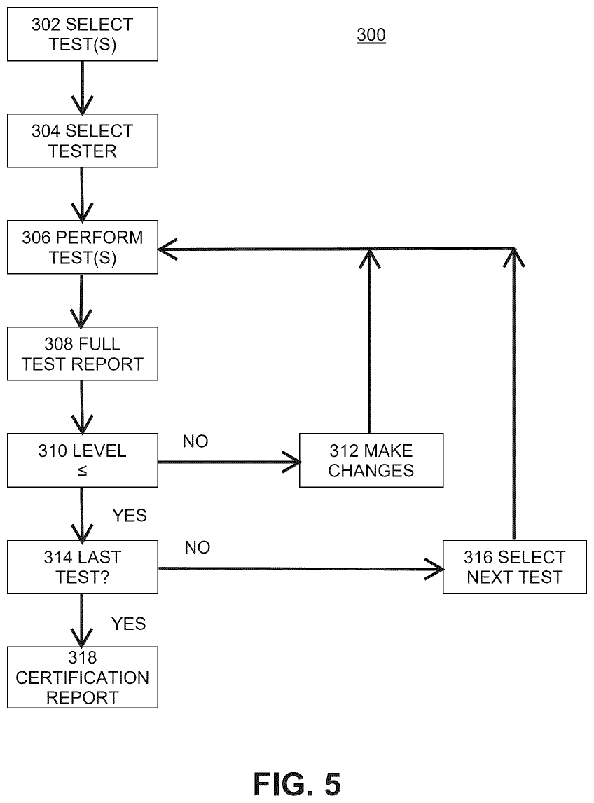

The software developer typically prefers that the information displayed in FIG. 4 not be disclosed to an enterprise organization contemplating adding the software program to the enterprise system 200 and or the devices 104 and 106. The method according to the invention provides a process by which the level of security vulnerability of the software application is certified to the organization without disclosing the security vulnerability confidential information of the developer. FIG. 5 is a flow chart that illustrates a method 300 for testing the level of security vulnerabilities in a software application and certifying the results according to the invention. The method 300 begins when the organization has identified a particular software application available from a developer. In a step 302, the organization selects at least one security vulnerability test to be run on the identified software application. The selected test could be dynamic application security testing (DAST) that scans the build for security flaws, such as weak passwords or missing credentials, or interactive application security testing (IAST) that analyzes traffic and execution flow to detect security issues, including those in third-party or open source components, as two examples. The organization might also select at least one additional test to be performed. For example, the additional test(s) could be: unit testing that validates new features and functions added to the previous version of the software application; regression testing that verifies that changes or additions do not harm previous features; integration testing that ensures the build operates with other applications or services; user acceptance testing that assesses whether the organization is able to use new features and functions as intended; and performance testing that ensures the build operates as required under load. The test “selecting” can be performed by: 1) the organization proposing a test that is accepted by the developer; 2) the developer proposing a test that is accepted by the organization; or the developer and the organization reviewing available tests and agreeing upon one of the tests.

In a step 304, the organization selects a third party tester to perform the at least one security vulnerability test and any other selected tests. The tester “selecting” can be performed by: 1) the organization proposing a tester that is accepted by the developer; 2) the developer proposing a tester that is accepted by the organization; or the developer and the organization reviewing suitable testers and agreeing upon one of the testers.

The organization and the developer provide the selected tester with a list of the test(s) to be performed, the information to be included in the full test report to the developer and the information to be included in the test certification report to the organization. In a step 306, the tester is provided access to the software application and performs the selected test(s) to detect security vulnerabilities and other software performance problems. In a step 308, the tester provides a full test report to the developer. The full test report lists all of the detected vulnerabilities such as shown in FIG. 4. In a step 310, the vulnerability level is checked. If the detected vulnerabilities are at a level above a security vulnerability level acceptable to the organization, the developer can make changes to the software application to eliminate the vulnerabilities in a step 312 and return to the testing step 306 to retest the software application.

If the detected vulnerabilities are at security vulnerability level acceptable to the organization in the step 310, a step 314 is performed to check whether the current test was the last test to be performed. If not, the next test is selected in a step 316 and the method returns to the step 306 where the tester performs the next test. If the current test was the last test to be performed the method branches from the step 314 and the tester provides to the organization a test certification report in a step 318. The certification report verifies that all of the selected tests were performed and that the software application has an acceptable level of security vulnerability. The certification report does not disclose to the organization any security vulnerabilities discovered during performance of the security vulnerability test(s).

The steps of the method 300 described above and illustrated in FIG. 5 provide a means for an organization to obtain an evaluation of the security vulnerability level of a developer's software application without compromising confidential information of the developer.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A method for certifying a level of security vulnerability of a software application to an organization prior to acquisition of the software application from a developer, the method comprising steps of:
selecting a security vulnerability test to be performed on the software application;
setting an acceptable level of security vulnerability for the software application as determined by the security vulnerability test;
selecting a tester to perform the security vulnerability test;
the tester operating a computing system to perform the security vulnerability test on the software application, the computing system generating a full test report of results of the security vulnerability test including a determined level of security vulnerability of the software application;
the developer receiving the full test report from the tester;
when the determined level of security vulnerability equals or is less than the acceptable level of security vulnerability, the developer authorizing the tester to provide to the organization a certification report including verification that the security vulnerability test was performed and that the determined level of security vulnerability is equal to or is less than the acceptable level of security vulnerability, the certification report excluding disclosure of any security vulnerabilities discovered during performance of the security vulnerability test; and
the tester providing the certification report to the organization.

2. The method according to claim 1 wherein the full test report includes details of all security vulnerabilities discovered during performance of the security vulnerability test.

3. The method according to claim 1 wherein the security vulnerability test is a dynamic application security test or an interactive application security test.

4. The method according to claim 1 including a step of, when the determined level of security vulnerability exceeds the acceptable level of security vulnerability, the developer makes at least one change to the software application and the method returns to the step of performing the security vulnerability test.

5. The method according to claim 1 including a step of selecting an additional test to be performed on the software application by the tester, the additional test being one of unit testing, dynamic application security testing, interactive application security testing, regression testing, integration testing, user acceptance testing, and performance testing.

6. The method according to claim 5 including a step of, when the results of the testing indicate that the determined level of security vulnerability equals or is less than the acceptable level of security vulnerability, performing the additional test on the software application and including results of the additional test in the full test report.

7. The method according to claim 1 including a step of selecting additional tests to be performed on the software application by the tester and, when the results of the testing indicate that the determined level of security vulnerability equals or is less than the acceptable level of security vulnerability, performing the additional tests on the software application and including results of the additional tests in the full test report.

8. The method according to claim 7 including after each of the additional tests is performed checking whether all of the additional tests were performed.

9. The method according to claim 7 including a step of, when the results of the testing for each of the additional tests indicate that a determined level of security vulnerability equals or is less than an acceptable level of security vulnerability, including results of the additional test in the full test report and selecting another of the additional tests to be performed.

10. The method according to claim 9 wherein the certification report includes verification that the additional tests were performed and that the software application equals or is less than the acceptable level of security vulnerability for each of the additional tests.

11. A method for application security posture management prior to acquisition of a software application by an organization, the method comprising steps of:
selecting a security vulnerability test to be performed on the software application;
selecting an additional test to be performed on the software application;
setting, by the organization, an acceptable level of security vulnerability for the software application;
selecting a tester to perform the tests;
the tester operating a computing system to perform the tests on the software application, the computing system generating a full test report of results of the testing including a determined level of security vulnerability of the software application;
the developer receiving the full test report from the tester; and
when the determined level of security vulnerability equals or is less than the acceptable level of security vulnerability, the tester providing to the organization a certification report including verification that the tests were performed and that the software application equals or is less than the acceptable level of security vulnerability, the certification report excluding disclosure of any security vulnerabilities discovered during performance of the tests.

12. The method according to claim 11 wherein the full test report includes details of all security vulnerabilities discovered during performance of the security vulnerability test.

13. The method according to claim 11 wherein the additional test is one of unit testing, dynamic application security testing, interactive application security testing, regression testing, integration testing, user acceptance testing, and performance testing.

14. The method according to claim 13 including a step of, when the results of the testing indicate that the determined level of security vulnerability equals or is less than the acceptable level of security vulnerability, performing the additional test on the software application and including results of the additional test in the full test report.

15. The method according to claim 14 wherein the certification report includes verification that the additional tests were performed and that the determined level of security vulnerability equals or is less than the acceptable level of security vulnerability for each of the additional tests.

16. A tester computing system configured to implement a method for certifying a level of security vulnerability of a software application from a developer prior to acquisition of the software application by an organization, the computing system comprising:
a non-transitory storage device;
a processor operatively coupled with the storage device;
a communication interface coupled with the processor, in communication with a computing system of a developer of a software application and in communication with a computing system of a software application tester;
a software security management application stored in the storage device and including executable code that, when executed, causes the processor to,
select a security vulnerability test to be performed on the developer software application;
set an acceptable level of security vulnerability for the developer software application as determined by the security vulnerability test;
perform the security vulnerability test on the developer software application and to generate to the developer a full test report of results of the testing including a determined level of security vulnerability of the developer software application;
when the determined level of security vulnerability equals or is less than the acceptable level of security vulnerability, generate a certification report including verification that the security vulnerability test was performed and that the determined level of security vulnerability equals or is less than the acceptable level of security vulnerability, the certification report excluding disclosure of any security vulnerabilities discovered during performance of the security vulnerability test; and
provide the certification report to the organization.

17. The computing system according to claim 16 wherein the full test report includes details all security vulnerabilities discovered during performance of the security vulnerability test.

18. The computing system according to claim 16 wherein the security vulnerability test is a dynamic application security test or an interactive application security test.

19. The computing system according to claim 16 wherein the processor selects an additional test to be performed on the software application by the tester, the additional test being one of unit testing, dynamic application security testing, interactive application security testing, regression testing, integration testing, user acceptance testing, and performance testing.

20. The computing system according to claim 16 wherein the processor selects additional tests to be performed on the software application by the tester and wherein the certification report includes verification that the additional tests were performed and that the software application equals or is less than the acceptable level of security vulnerability for each of the additional tests.
